(19) United States
(12) Patent Application Publication
(10) Pub. No.: US 2006/0256684 A1
(43) Pub. Date: Nov. 16, 2006

(54) Optical information recording and reproducing apparatus

(75) Inventor: Tatsushi Katayama, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/414,183

(22) Filed: May 1, 2006

(30) Foreign Application Priority Data
May 10, 2005 (JP) 2005-137313

(51) Int. Cl. G11B 5/09

(52) U.S. Cl. 369/47.36

(57) ABSTRACT

Provided is an optical information recording and reproducing apparatus, including: a circuit for recording information on an information recording medium or reproducing the information recorded thereon; a storing circuit for storing linear velocities for the information recording medium based on power consumption at recording and reproduction; and a setting circuit for separately setting linear velocities at recording and reproduction based on the linear velocities for recording and reproduction which are stored in the storing circuit. According to the optical information recording and reproducing apparatus, an optimum linear velocity at which power consumption at the time of recording or reproduction becomes minimum can be set and thus it is possible to constantly obtain an optimum power saving effect.

### BACKGROUND OF THE INVENTION

1. Field of the Invention

The present invention relates to an optical information recording and reproducing apparatus for recording information on an optical information recording medium such as an optical disk or a magneto-optical disk or reproducing the recorded information therefrom, and more particularly, to a technique for reducing power consumption of an apparatus.

2. Related Background Art

Up to now, an apparatus for intermittently reproducing information recorded on an optical disk such as a CD or a magneto-optical disk such as an MD has been widely known to reduce power consumption of an apparatus for reproducing the information. According to this apparatus, because a compressed information signal is recorded, the information intermittently reproduced from the disk is stored in a memory. When sufficient information is stored in the memory, a reproducing apparatus is stopped and the power supply is suspended to reduce the power consumption of the entire apparatus.

FIGS. 17A to 17C are schematic diagrams showing intermittent recording. FIG. 17A shows a change in data accumulation amount of the memory. FIG. 17B shows a drive stop control signal and a drive start control signal. FIG. 17C shows a control signal for recording timing. In order to perform an intermittent recording operation, a threshold value Th is set for the data accumulation amount of the memory. While the drive is stopped, data are successively accumulated in the memory. When the data accumulation amount reaches the threshold value Th at a time t1, the drive starts and servo control is performed to seek a predetermined track. After the seeking is completed, recording starts at a time t2 to record data stored in the memory on the disk. Then, the drive is stopped again at a time t3. As described above, the recording is performed while the stopping and the starting are alternately repeated, thereby reducing the power consumption.

According to an apparatus disclosed in Japanese Patent Application Laid-Open No. 2002-074820, in view of a power saving effect determined based on a ratio between an operating time and a stopping time during the intermittent recording operation and power consumption determined based on a motor rotation number, a linear velocity and a disk rotation number are controlled in accordance with a reproducing position of the disk in a radius direction thereof so as to minimize the power consumption.

According to the conventional reproducing system, the average power consumption of the entire apparatus is minimized by the control based on the linear velocity and the disk rotation number which are designed in advance corresponding to a position in the radius direction.

However, in general, a power consumption state caused at actual reproduction is not necessarily identical to that intended at design. For example, when decentering is large because of individual disk difference, a load caused at servo tracking increases. Therefore, the power consumption of the entire apparatus may be reduced by the control based on a rotation number smaller than a rotation number in which the power consumption intended at design becomes minimum. The linear velocity at which the power consumption becomes minimum changes depending on a variation in power consumption of a laser, an environmental temperature, and the like.

According to Japanese Patent Application Laid-Open No. 2002-074820 described above, the power consumption of the entire apparatus is minimized at the time of reproduction. However, the power consumption required for the case of recording is not taken into account.

### SUMMARY OF THE INVENTION

Therefore, an object of the present invention is to provide an optical information recording and reproducing apparatus capable of constantly obtaining an optimum power saving effect at the time of each of recording and reproduction.

According to the present invention, linear velocities which are stored in advance and at which power consumption at the time of each of recording and reproduction becomes minimum are separately set for recording and reproduction. Thus, an optimum power saving effect can be constantly obtained.

To be specific, according to an aspect of the present invention, an optical information recording and reproducing apparatus includes: a circuit for performing one of recording information on an information recording medium and reproducing the information recorded thereon; a storing circuit for storing linear velocities for the information recording medium based on power consumption at recording and reproduction; and a setting circuit for separately setting linear velocities at recording and reproduction based on the linear velocities for recording and reproduction which are stored in the storing circuit.

### BRIEF DESCRIPTION OF THE DRAWINGS

FIG. 1 is a block diagram showing a first embodiment of the present invention;

FIG. 2 shows a breakdown of power consumption at the time of each of recording and reproduction;

FIG. 3 is a flow chart for explaining an operation according to the first embodiment of the present invention;

FIG. 4 is a block diagram showing a second embodiment of the present invention;

FIG. 5 is a flow chart for explaining an operation according to the second embodiment of the present invention;

FIG. 6 is a flow chart for explaining linear velocity setting processing according to the second embodiment of the present invention;

FIG. 7 is a flow chart for explaining the linear velocity setting processing according to the second embodiment of the present invention;

FIGS. 8A and 8B are explanatory diagrams showing a relationship between last power consumption and last but one power consumption in a case where a linear velocity is set;

FIG. 9 shows an example in a case where last but one power consumption is larger than last power consumption;

FIG. 10 shows an example in a case where last power consumption is larger than last but one power consumption;

FIG. 11 shows a relationship between the linear velocity and recording laser power;

FIG. 12 is an explanatory diagram showing an example in which a servo deviation is monitored to control the linear velocity;

FIG. 13 is a flow chart for explaining an operation according to a third embodiment of the present invention;

FIG. 14 shows a relationship between the linear velocity and the power consumption;

FIG. 15 shows a relationship between a radius position of an optical disk and an optimum linear velocity for power saving;

FIG. 16 is an explanatory diagram showing a method of calculating the optimum linear velocity in the radius position of the optical disk;

FIGS. 17A, 17B and 17C are explanatory diagrams showing an intermittent recording operation;

FIGS. 18A and 18B are explanatory graphs showing a relationship between the linear velocity and the power consumption during the intermittent recording operation;

FIGS. 19A and 19B are explanatory graphs showing a change in power consumption at each of recording and reproduction; and

FIG. 20 shows a change in power consumption with respect to the linear velocity at each of recording and reproduction.

### DESCRIPTION OF THE PREFERRED EMBODIMENTS

Hereinafter, best embodiments for carrying out the present invention will be described in detail with reference to the accompanying drawings.

### First Embodiment

The inventor of the present invention has repeated thorough studies and developments. As a result, the inventor(s) found that optimum linear velocities necessary to save powers at the times of recording and reproduction are not necessarily equal to each other. The present invention has been made based on such a finding.

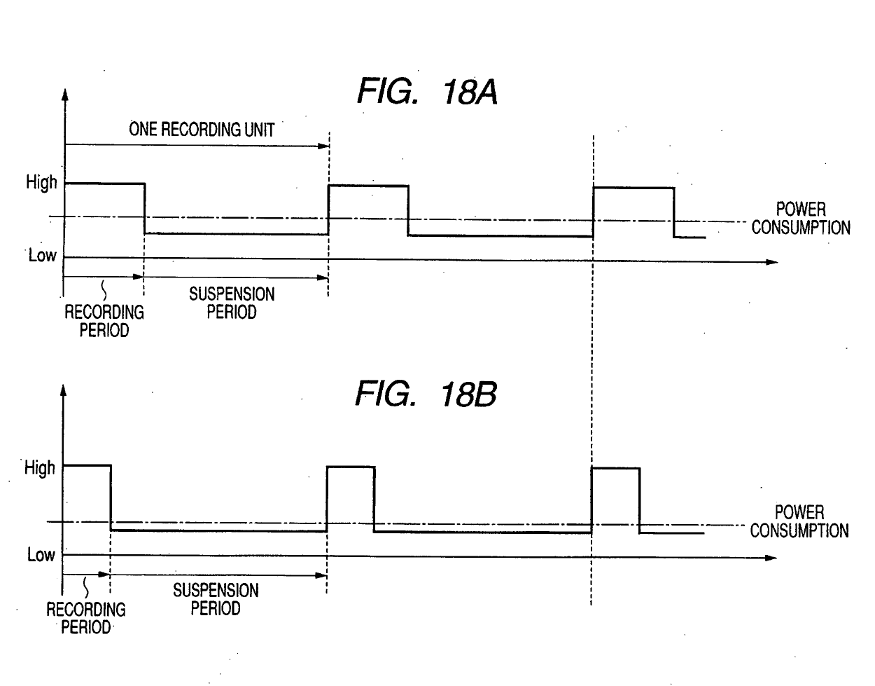

A relationship between a linear velocity and power consumption will be described with reference to FIGS. 18A and 18B.

FIG. 18A shows a timing in a recording operation in a case where the linear velocity is a normal speed. A recording unit is set to, for example, a time necessary to accumulate video data of 10 seconds at a predetermined rate in a memory. In a case where the linear velocity is the normal speed, when the video data of 10 seconds is accumulated in the memory, recording is performed for a period of “High” as shown in FIG. 18A. After that, servo control is stopped and an apparatus is on standby in a power saving state.

FIG. 18B shows a timing in a case of double speed. As in the case shown in FIG. 18A, recording is performed for a period of “High” and then enters into a suspension period. As shown in FIGS. 18A and 18B, when the linear velocity increases, it is found that average power consumption of the entire apparatus can be reduced because the suspension period lengthens with respect to a ratio between the recording period and the suspension period.

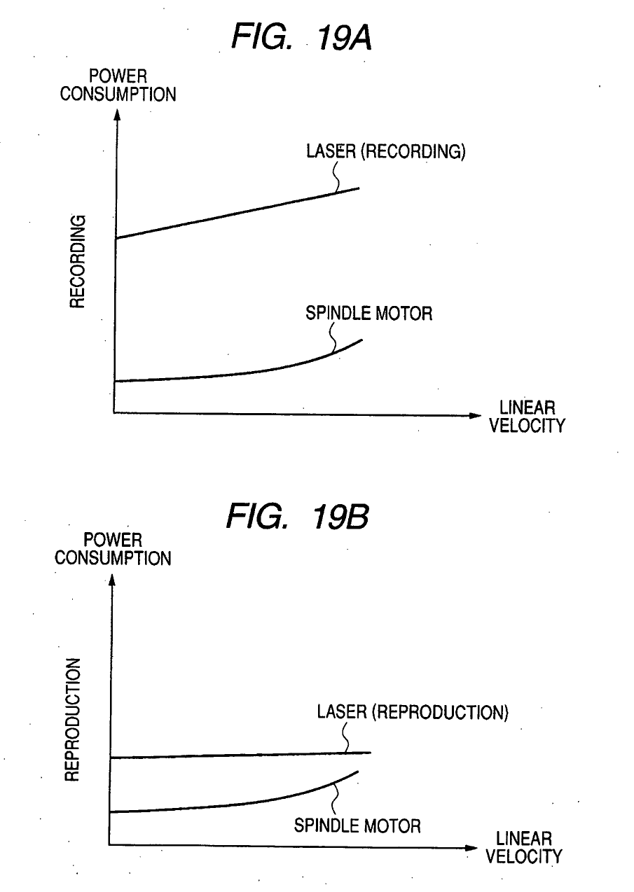

FIGS. 19A and 19B each show a relationship between the linear velocity and the power consumption at each time of recording and reproduction.

As shown in FIGS. 19A and 19B, when the linear velocity increases, the power consumption of a spindle motor similarly increases at the time of each of recording and reproduction. In contrast to this, the power consumption of a laser increases according to the linear velocity at the time of recording, but a change in power consumption thereof is small at the time of reproduction. An absolute value of the power consumption at the time of recording becomes twice or more often than at the time of reproduction.

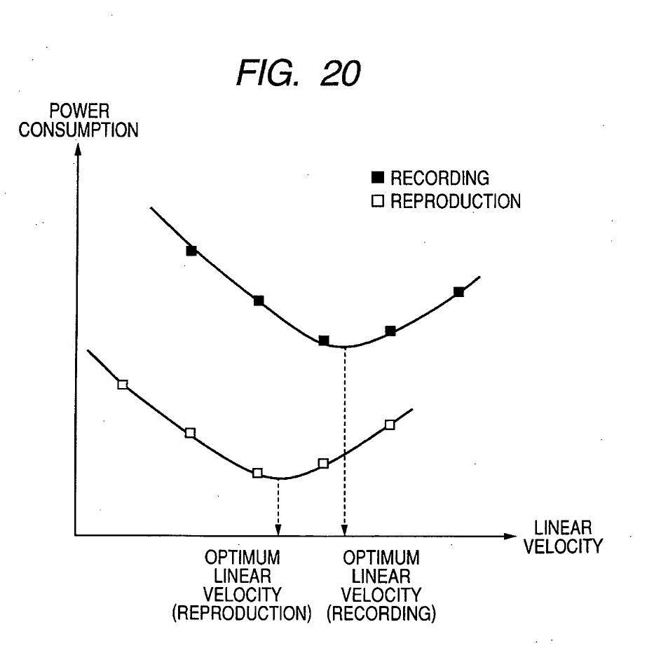

Therefore, when a change in power consumption of the entire apparatus with an intermittent operation is measured based on the linear velocity as a parameter, a result as shown in FIG. 20 is obtained. Thus, the optimum linear velocities necessary to save powers in the cases of recording and reproduction are not necessarily equal to each other.

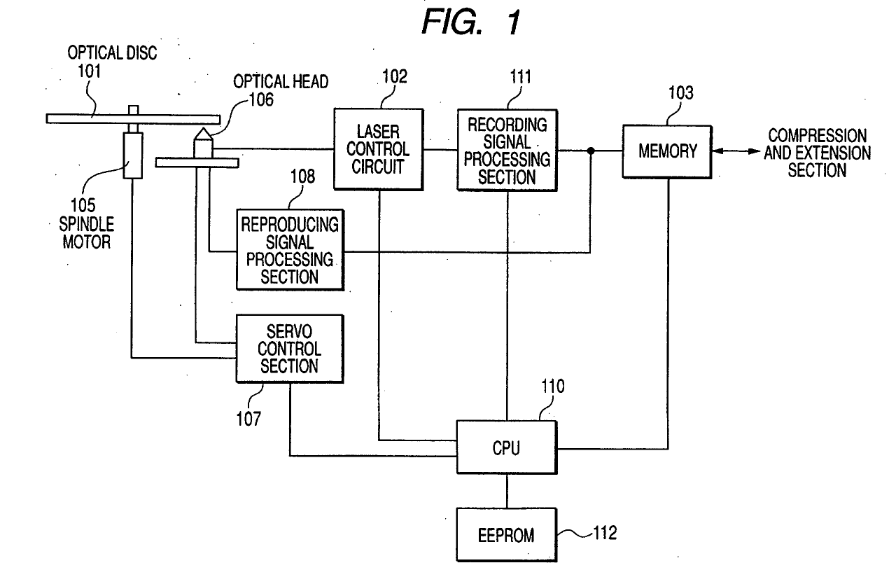

FIG. 1 is a block diagram showing an optical information recording and reproducing apparatus according to a first embodiment of the present invention.

In FIG. 1, the optical information recording and reproducing apparatus includes an optical disk 101 which is an information recording medium, a spindle motor 105 for rotating the optical disk 101, an optical head 106 for irradiating a light beam to the optical disk 101 to record information thereon and reproduce information therefrom, and a laser control circuit 102 for driving a semiconductor laser provided in the optical head 106 to perform laser power control and the like.

The optical information recording and reproducing apparatus further includes a recording signal processing section 111 for modulating data from a memory 103 to produce a recording pattern, a reproducing signal processing section 108 for processing a reproducing signal from the optical disk 101 to produce decoding data and outputting the decoding data to the memory 103, and a servo control section 107 for performing control operations such as focusing and tracking or the rotation number control operation of the spindle motor 105. A motor rotation number can be measured by detecting an FG signal by the servo control section 107.

The optical information recording and reproducing apparatus further includes the memory 103 for storing, for example, data to be recorded or reproduced, an EEPROM 112 for storing, for example, specific apparatus information necessary to optimally control the apparatus, and a CPU 110 for controlling the entire apparatus. The EEPROM 112 can also store control information obtained during the operation of the apparatus.

In the apparatus according to this embodiment, the linear velocities at the times of recording and reproduction are separately set based on power consumption.

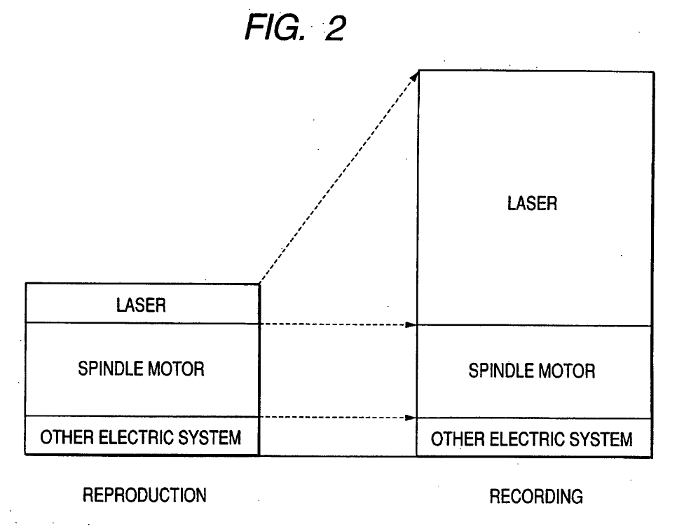

As shown in FIG. 2, in the case of recording, the power consumption caused by recording laser power is large. Therefore, when the linear velocity is increased to increase the ratio of the suspension period to the recording period at the time of intermittent operation, a power saving effect becomes larger. On the other hand, in the case of reproduction, laser power becomes reproducing power, so a ratio of the power consumption of the laser to that of the entire apparatus reduces, thereby increasing a ratio of the power consumption of the spindle motor to that of the entire apparatus. Therefore, optimum linear velocity values for power saving at each time of recording and reproduction are different from each other.

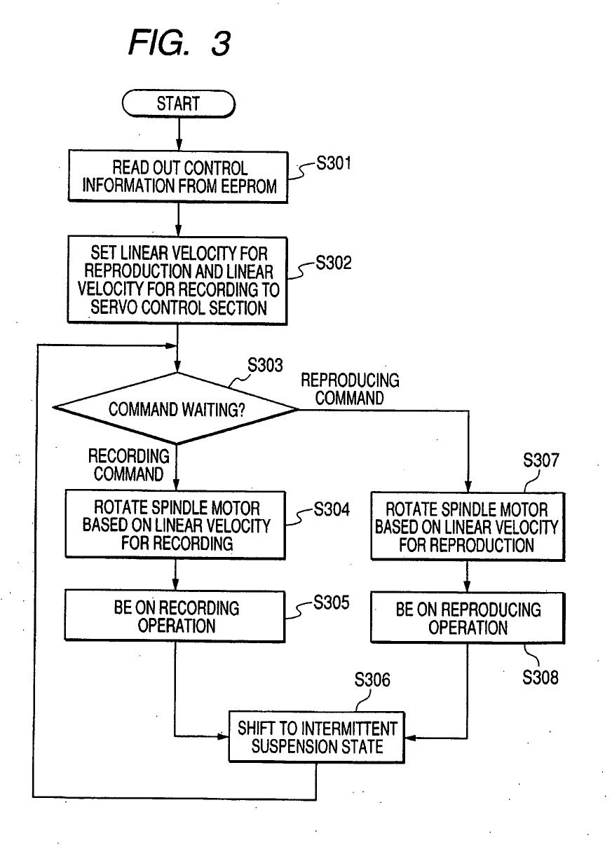

Next, an operation of the apparatus will be described with reference to a flow chart shown in FIG. 3. Power consumptions of the laser, the spindle motor, the electrical circuits, and the like, which are used for the apparatus, are measured at a predetermined intermittent ratio (which may be set to an average intermittent ratio). The optimum linear velocities for power saving at the times of recording and reproduction, which are obtained based on the measured power consumptions are stored in advance in the memory (memory 103 or EEPROM 112). The measurement may be performed in a factory or the like at the time when the apparatus is manufactured. Values specified when the apparatus is designed may be used as the optimum linear velocities.

In Step S301, as described above, the CPU 110 reads out the control information stored in advance in the memory to obtain linear velocities for recording and reproduction. Then, in Step S302, the obtained linear velocities are set to the servo control section 107. Other control information is initialized if necessary. After that, in Step S303, the apparatus is shifted to a command waiting state in which the apparatus waits for a recording or reproducing instruction.

After recording starts, video data is accumulated in the memory 103. When an accumulation amount becomes equal to or larger than a predetermined value, a recording command is issued to the apparatus. Then, in Step S304, the spindle motor 105 is rotated at the linear velocity for recording. In Step S305, the video data is recorded on the optical disk 101 at recording laser power. After the recording is completed, the apparatus is shifted to a suspension state for the intermittent operation.

In the case of reproduction, when the reproduction starts, the spindle motor 105 is rotated at the linear velocity for reproduction in Step S307. In Step S308, data is reproduced from the optical disk 101 at reproducing laser power and accumulated in the memory 103. When an accumulation amount becomes equal to or larger than a predetermined value, the apparatus is shifted to the suspension state for the intermittent operation in Step S306. The above-mentioned operation is repeated to perform recording processing or reproducing processing.

In this embodiment, the spindle motor is operated at the linear velocity at which the power consumption becomes minimum at the time of each of recording operation and reproducing operation. Therefore, power saving can be significantly improved. In particular, when the apparatus is to be used in mobile environments, this operation is very effective in view of the limitations on battery capacity and the like.

The example in which the optimum linear velocities are set based on only the power consumption is described above. Information with respect to signal quality (amplitude of reproducing signal or the like), servo deviation (focus error signal and tracking error signal), or the like may be evaluated together with the power consumption to set the optimum linear velocities. For example, the amplitude of the reproducing signal or the amplitude of the tracking error signal is measured. Then, when the measured amplitude is equal to or larger than a predetermined value, the linear velocities are set as described above.

### Second Embodiment

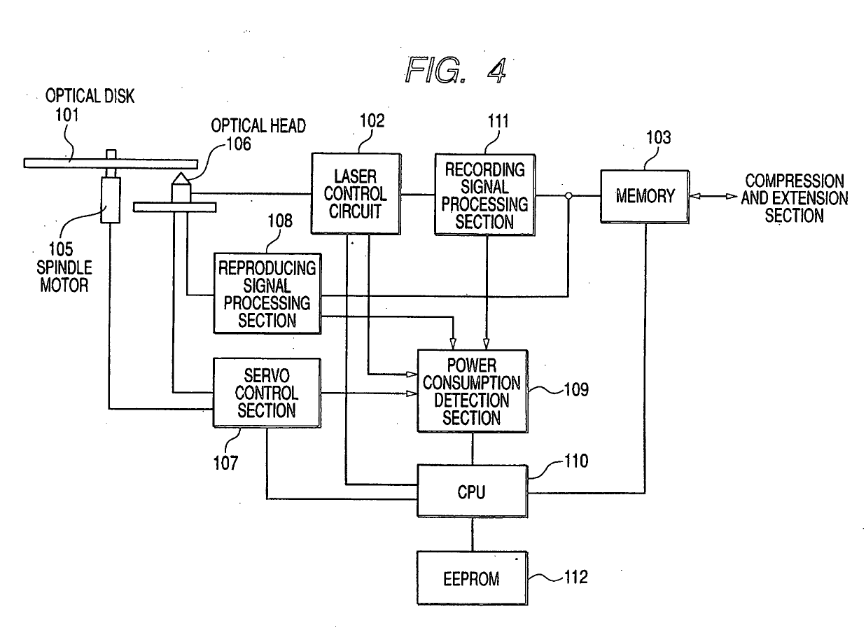

FIG. 4 is a block diagram showing an optical information recording and reproducing apparatus according to a second embodiment of the present invention. In FIG. 4, the same reference numerals are given to the same parts as those shown in FIG. 1. In FIG. 4, the optical information recording and reproducing apparatus includes the optical disk 101, the spindle motor 105 for rotating the optical disk 101, the optical head 106, and the laser control circuit 102 for performing laser power control and the like.

The optical information recording and reproducing apparatus further includes the recording signal processing section 111 for modulating data from the memory 103 to produce a recording pattern, the reproducing signal processing section 108 for processing a reproducing signal from the optical disk 101 to produce decoding data and outputting the decoding data to the memory 103, and the servo control section 107 for performing the control operations such as focusing and tracking or the rotation number control operation of the spindle motor 105. The motor rotation number can be measured by detecting an FG signal by the servo control section 107.

The optical information recording and reproducing apparatus further includes the memory 103 for storing, for example, data to be recorded or reproduced, a power consumption detecting section 109 for detecting power consumption of each part of the apparatus, and the CPU 110 for controlling the entire apparatus.

In order to explain the linear velocity control, an operational sequence in a case where a compressed video signal is recorded on the optical disk will be described below.

Information is recorded on the optical disk along a spiral track extended from the inner circumference to the outer circumference. Recording and reproduction are performed on the optical disk in a predetermined data unit. This unit is referred to as a cluster.

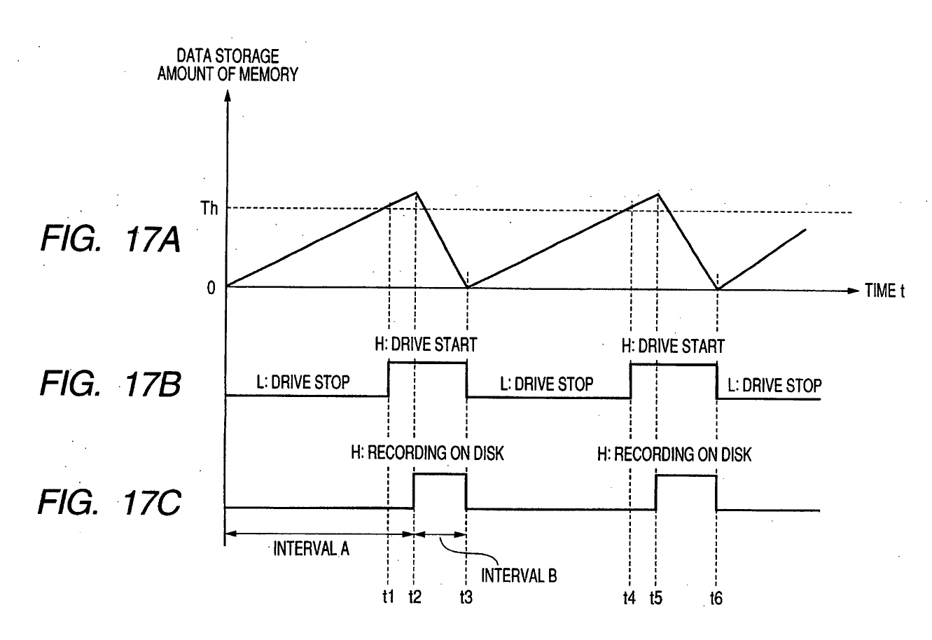

As shown in FIGS. 17A to 17C, in the case of intermittent recording, the stopping and the starting are alternately repeated to record a video signal. For example, when the video signal is stored in the memory 103 at a rate of 10 Mbps and recorded on the optical disk at a rate of 40 Mbps, data of 10 seconds which is stored in the memory 103 during an interval “A” shown in FIG. 17C is recorded on the optical disk for approximately 3 seconds during an interval “B”. Therefore, the apparatus can be stopped for approximately 7 seconds to achieve power saving. When each recording (corresponding to the interval “B”) is set as a cluster, data corresponding to several tens to several hundreds of clusters is recorded.

In order to reduce the power consumption, it is desirable that a recording time corresponding to the interval “B” be minimized to increase a ratio of the suspension interval “A” to the recording time. Therefore, it is necessary to increase the linear velocity of the optical disk at the time of recording to improve a recording rate.

In contrast to this, when the rotation number is increased to obtain a high linear velocity, the power consumption of the motor, the laser power, and the power for servo control also increase. As a result, a state occurs in which the power consumption of the entire apparatus increases.

The linear velocity at which the power consumption becomes minimum changes depending on individual differences of the optical disk, the laser, the motor, and the like and a variation in environment including a temperature.

In this embodiment, the power consumption is measured for the recording period. A result obtained by measurement is stored together with the linear velocity at this recording in the memory (memory 103 or EEPROM 112). Then, at the time of recording for a next recording period, the linear velocity is shifted to a plus side or a minus side relative to a last linear velocity and the shifted linear velocity is recorded. At this time, power consumption and a linear velocity are stored in the memory. The above-mentioned processing is performed for each recording period to control the linear velocity so as to continuously reduce the power consumption.

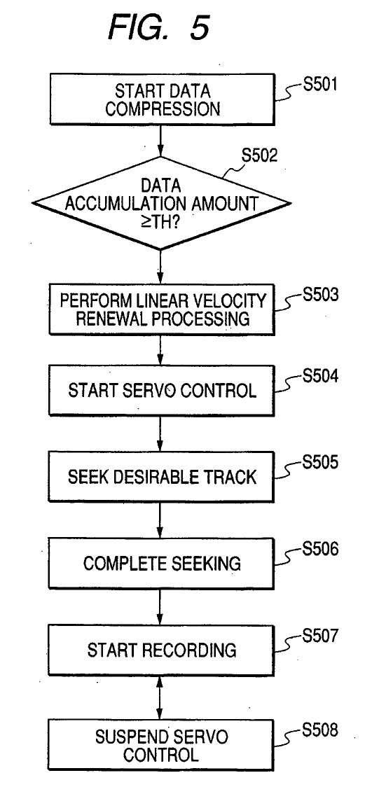

FIG. 5 is a control flow chart of this case. A linear velocity controlling method of this embodiment will be described with reference to the flow chart of FIG. 5.

When data compression starts in Step S501, the data accumulation amount of the memory 103 is monitored in Step S502. When the data accumulation amount reaches a threshold value Th, it is checked whether or not a linear velocity and power consumption at time of previous recording are stored in the memory in Step S503.

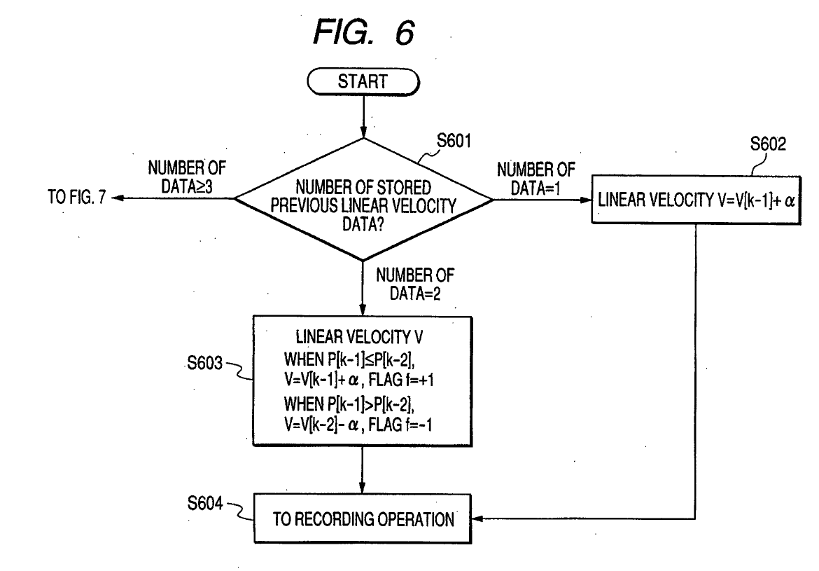

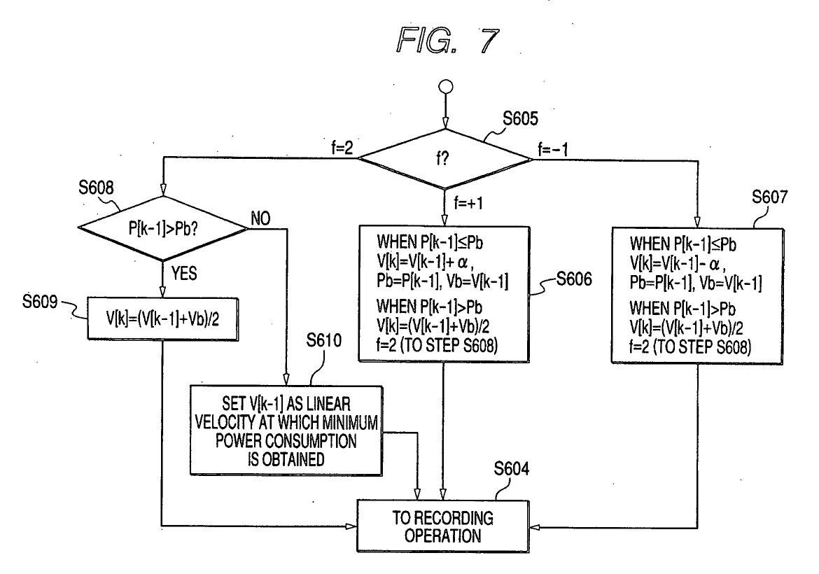

When the linear velocity is not stored, a predetermined linear velocity is set. In Step S504, servo control starts. On the other hand, when the previously recorded linear velocity is stored in the memory, the following processing is performed to set the linear velocity in Step S503. This processing will be described with reference to flowcharts of FIGS. 6 and 7.

In Step S601, the number of stored previous linear velocity data is checked. When the number of stored linear velocity data is one, a linear velocity obtained by adding a predetermined amount to last linear velocity data is set in Step S602. That is, when the last linear velocity is expressed by V[k−1], the linear velocity obtained by adding a predetermined amount α to V[k−1] is set.

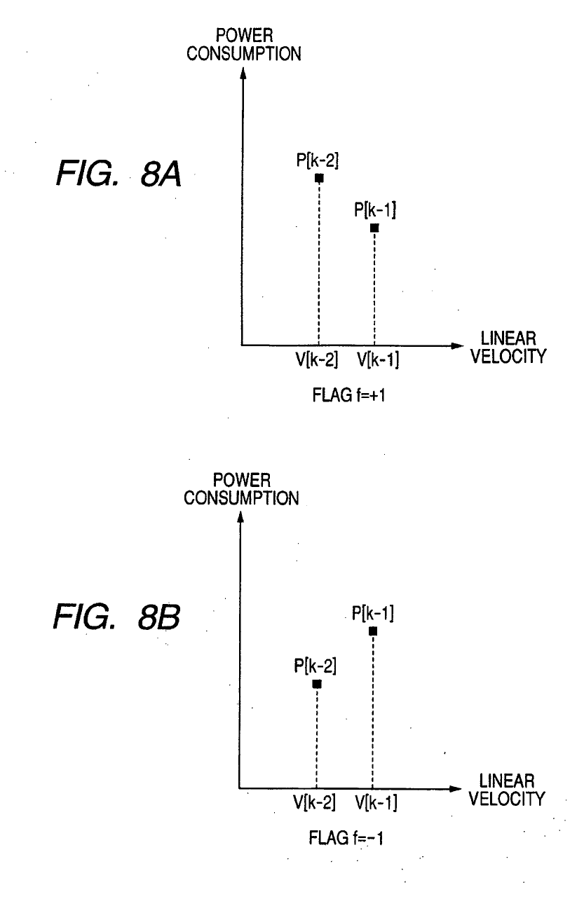

When the number of stored linear velocity data is two, processing proceeds to Step S603. In Step S603, as shown in FIGS. 8A and 8B, it is assumed that a last linear velocity and last power consumption are expressed by V[k−1] and P[k−1] and a last but one linear velocity and last but one power consumption are expressed by V[k−2] and P[k−2]. In Step S603, a linear velocity at time of this recording is set based on the linear velocities and the power consumptions.

To be specific, the power consumptions are compared with each other.
When P[k−1]≦P[k−2],V[k]=V[k−1]+α (1)
When P[k−1]>P[k−2],V[k]=V[k−2]−α (2)

That is, while the power consumption reduces, the linear velocity V is obtained by adding the predetermined amount α to the last linear velocity. On the other hand, when the power consumption increases, a linear velocity obtained by subtracting the predetermined amount α from the last but one linear velocity is set. In the case of (1) corresponding to FIG. 8A, a flag f is set to +1. In the case of (2) corresponding to FIG. 8B, the flag f is set to −1. After Steps S602 and 603, processing is shifted to a recording operation of Step S604 (Step S504 of FIG. 5).

In the case of (1), the smaller power consumption P[k−1] and the linear velocity V[k−1] at this time are stored in the memory as Pb and Vb, respectively. On the other hand, in the case of (2), P[k−2] and V[k−2] are stored as Pb and Vb, respectively. That is, the previously set linear velocity value and the minimum power consumption value associated therewith are stored as Pb and Vb. These values are used for next linear velocity setting.

After that, processing is shifted to the flowchart of FIG. 7 through Step S601 of FIG. 6. Then, as shown in FIG. 7, a linear velocity V[k] is set based on the last power consumption value P[k−1], the last linear velocity value V [k−1], the previous minimum power consumption value Pb, the previous linear velocity value Vb, and the flag f.

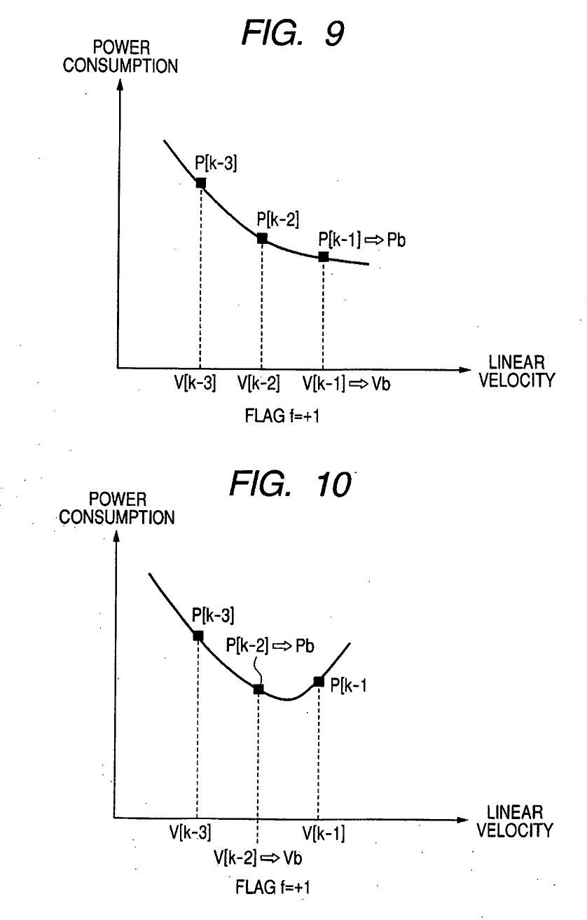

In Step S605 of FIG. 7, a value of the flag f is checked. In the case of f=+1 as shown in FIG. 9, processing proceeds to Step S606. At this time, when P[k−1]≦Pb, the linear velocity is set by the following expression.
V[k]=V[k−1]+α

When P[k−1]>Pb, as shown in FIG. 10, it is highly possible that a minimum power consumption value is between the power consumptions P[k−1] and Pb. Therefore, the linear velocity is set as follows and the flag f is set to 2.
V[k]=(V[k−1]+Vb)/2

Next, when the flag f=−1 in Step S605, processing proceeds to Step S607. At this time, when P[k−1]≦Pb, the linear velocity is set by the following expression.
V[k]=V[k−1]−α

When P[k−1]>Pb, as shown in FIG. 10, it is highly possible that a minimum power consumption value is between the power consumptions P[k−1] and Pb. Therefore, the linear velocity is set as follows and the flag f is set to 2.
V[k]=(V[k−1]+Vb)/2

Next, processing is shifted to the recording operation of Step S604 as in the case shown in FIG. 6. After that, in the case of f=+1, the processing of Step S606 is executed next time. In the case of f=−1, the processing of Step S607 is executed next time.

Next, when f=2 in Step S605, processing proceeds to Step S608. The case of f=2 indicates that the power consumption is changed from a decrease to an increase. Even in this case, processing is changed based on a condition. When P[k−1]≦Pb, processing proceeds to Step S610 to set V[k−1] as a linear velocity at which minimum power consumption is obtained.

When P[k−1]>Pb, processing proceeds to Step S609 and the following is calculated.
V[k]=(V[k−1]+Vb)/2

The linear velocity to be set is obtained by simple average calculation V[k]=(V[k−1]+Vb)/2. The linear velocity may be set by weighted average calculation in view of power consumption values.

A ratio k in the case of weighted average is calculated as follows.
k=P[k−1]/(P[k−1]+Pb))

The linear velocity is set as follows based on the ratio k.
V[k]=(1−k)V[k−1]+kVb

Next, the linear velocity at which the power consumption becomes minimum is detected in Step S610, so the power consumption at this time and the linear velocity are stored in the memory. Other power consumption and other linear velocity data are deleted. That is, processing returns to Step S601 of FIG. 6, and a linear velocity at which power consumption becomes minimum is obtained again by searching. In such a case, because the linear velocity at which the power consumption becomes minimum is detected, the current linear velocity may be held.

When the linear velocity at which the power consumption becomes minimum is temporarily detected as described above, the step width α used to change the linear velocity can be shortened to improve search precision. When the linear velocity is set in Steps S609 and S610, processing proceeds to the recording operation of Step S604 (Step S504 of FIG. 5).

The above-mentioned power consumption is measured for periods during which intermittent recording is performed plural times on a user area. The linear velocity is set based on a result obtained by the measurement. It is also possible that a counter is incremented every time a bottom limit of power consumption is detected, and then the step width is adjusted based on a counter value to realize precision improvement.

When a difference between an address at the time of last recording and an address at the time of this recording is significantly large, a radius position of the optical disk is significantly shifted, so a variation in linear velocity to be set may be large. Therefore, when all the stored linear velocities are reset and recording is performed at a predetermined linear velocity, a time necessary to obtain an optimum value in which power consumption becomes minimum can be shortened in some cases.

After a suitable linear velocity is set by the above-mentioned series of processings, servo control starts in Step S504 of FIG. 5 to rotate the spindle motor so as to obtain the set linear velocity. When it is determined that the servo control including focusing and tracking is normally operated, seeking to a desirable track is performed for recording in Step S505. When the completion of seeking is determined in Step S506, an address is checked. Then, in Step S507, the data stored in the memory 103 is recorded on the optical disk 101. An amount of data recorded during a recording interval is separately set by a controller. A power consumption amount at this time is measured by the power consumption detecting section 109.

After recording of a desirable data amount is completed, in Step S508, the servo control is stopped and the apparatus is shifted to the suspension state. The power consumption amount at the time of recording is stored in the memory together with the linear velocity. Then, processing returns to Step S502, and the data accumulation amount of the memory 103 is monitored again. After that, the same processings as those described in FIGS. 2, 6, and 7 are repeated.

When the power consumption is to be measured for the recording period, a total power amount necessary to complete recording of predetermined user data is measured, and a value converted into a power amount per time is evaluated as a power consumption value. Then, an optimum linear velocity point is obtained as described above.

Here, setting of the linear velocity and a recording condition will be described. In general, when the linear velocity changes, an optimum recording laser power similarly changes. According to the apparatus of this embodiment, the recording signal processing section 111 shown in FIG. 4 operates to control the recording power in accordance with the linear velocity.

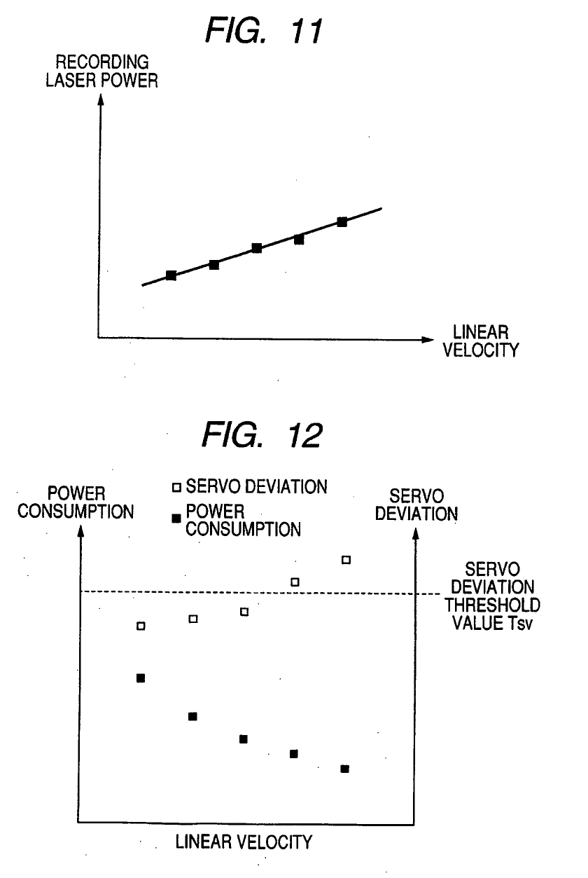

FIG. 11 shows a relationship between the linear velocity and the recording power. As shown in FIG. 11, when the linear velocity becomes higher, the laser power necessary for recording increases. Therefore, it is necessary to balance a merit in which the suspension period in the case where predetermined data is recorded by intermittent recording can be lengthened by an increase in linear velocity and a demerit in which the recording power increases. Thus, it is effective to limit the linear velocity based on the laser power.

In this embodiment, the linear velocity at which the power consumption becomes smaller is obtained and set using the method described with reference to FIGS. 8A to 10. However, when the linear velocity becomes higher, a load on the signal processing section increases to reduce the quality of a recoding signal in some cases. This reason is that, although it is necessary to increase the rotation number of the spindle motor with an increase in linear velocity, it is difficult to perform servo control following the increase in rotation number thereof.

Therefore, as shown in FIG. 12, a servo deviation of a tracking error signal or a focus error signal is monitored. When the servo deviation exceeds a predetermined value, it is also effective to limit the linear velocity. A line Tsv shown in FIG. 12 indicates a threshold value of the servo deviation. This value corresponds to a limit of the servo control. Thus, when the servo deviation is monitored during linear velocity searching and exceeds the threshold value, the control is performed so as not to set a linear velocity equal to or larger than the threshold value. When the signal quality (for example, amplitude of reproducing signal) instead of the servo deviation is monitored and reduces by a value equal to or larger than a predetermined value, the linear velocity may be limited.

As described above, in this embodiment, the linear velocity is adjusted at the time of recording, and the power consumption at this time is measured to obtain an optimum linear velocity for power saving. Therefore, high-precision control is possible, so that the power consumption can be reliably reduced. When the signal quality, the servo deviation, or the like is monitored in addition to the power consumption, the recording and reproducing performance whose level is equal to or higher than a predetermined level can be maintained, and the optimum control of the entire apparatus is possible. Note that, when information is reproduced from the optical disk, as in the above-mentioned case, the power consumption at the time of reproduction is measured, and the optimum linear velocity is set based on a result obtained by comparison between the last power consumption and the last but one power consumption.

### Third Embodiment

Next, a third embodiment of the present invention will be described. In this embodiment, while a linear velocity is changed in each of a plurality of radius positions of the optical disk, the power consumption is measured in advance to obtain data indicating a relationship between the linear velocity and the power consumption. This is referred to as a learning method. The apparatus has the same structure as that shown in FIG. 4. The power consumption detecting section 109 measures the power consumption. The CPU 110 performs the following learning processing to prepare a table indicating the relationship between the linear velocity and the power consumption. The optimum linear velocity is set based on the radius position of the optical disk at the time of recording or reproduction with reference to the table.

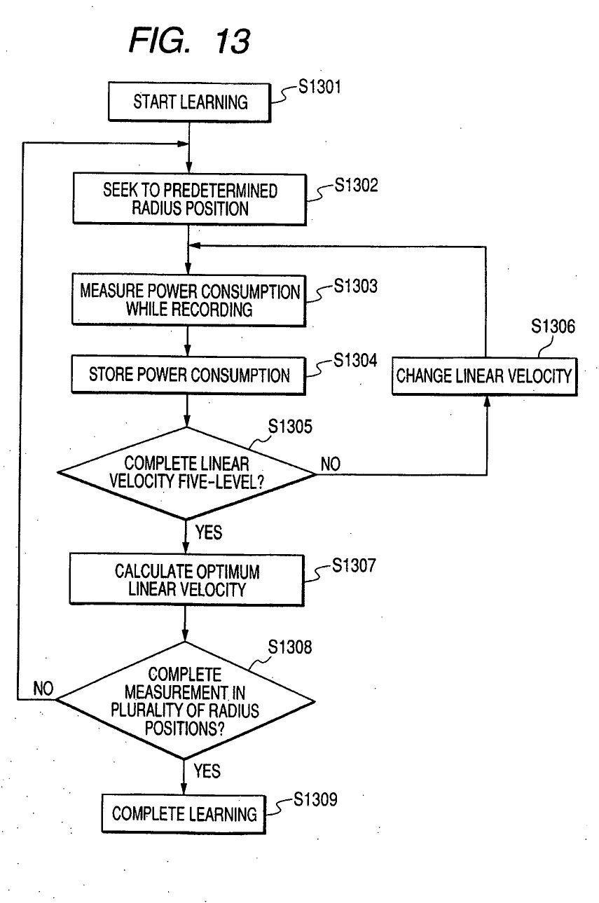

FIG. 13 is a flow chart showing the learning method according to this embodiment. When learning for obtaining the optimum linear velocity starts in Step S1301, seeking to a first radius position of the plurality of radius positions set in advance is performed in Step S1302. Then, in Step S1303, a first linear velocity is set, data corresponding to a predetermined number of clusters are recorded, and power consumption at this time is measured. After the recording is completed, the measured power consumption is stored in Step S1304.

In this embodiment, the linear velocity is changed in five levels in each of the radius positions to measure the power consumption. In Step S1305, it is determined whether or not five-level changing is completed. When the changing is not completed, the linear velocity is changed to a second linear velocity next to the first linear velocity in Step S1306. Then, the power consumption is measured again during the recording in Step 1303 and the obtained power consumption is stored. Therefore, the power consumptions are measured corresponding to the five levels of the linear velocity.

After the five-level changing is completed, the optimum linear velocity is calculated in Step S1307. FIG. 14 shows a relationship between the linear velocity and the power consumption. In Step S1307, linear velocities at times when a power consumption curve intersects with a level of a predetermined threshold value P are calculated by linear interpolation or the like. Here, the linear velocities at times when the power consumption curve intersects with the level of the threshold value P are expressed by Vp1 and Vp2. An average value Vp of Vp1 and Vp2 is set as the optimum linear velocity in the first radius position.

After the calculation of the optimum linear velocity in the first radius position is completed, it is determined whether or not the measurement in the plurality of radius positions set in advance is completed in Step S1308. When the measurement is not completed, processing returns to Step S1302 and seeking to the second radius position next to the first radius position is performed. As described above, the linear velocity is changed in the five levels to measure the power consumption and the optimum linear velocity in the second radius position is calculated. Therefore, the optimum linear velocities in the plurality of radius positions set in advance are calculated.

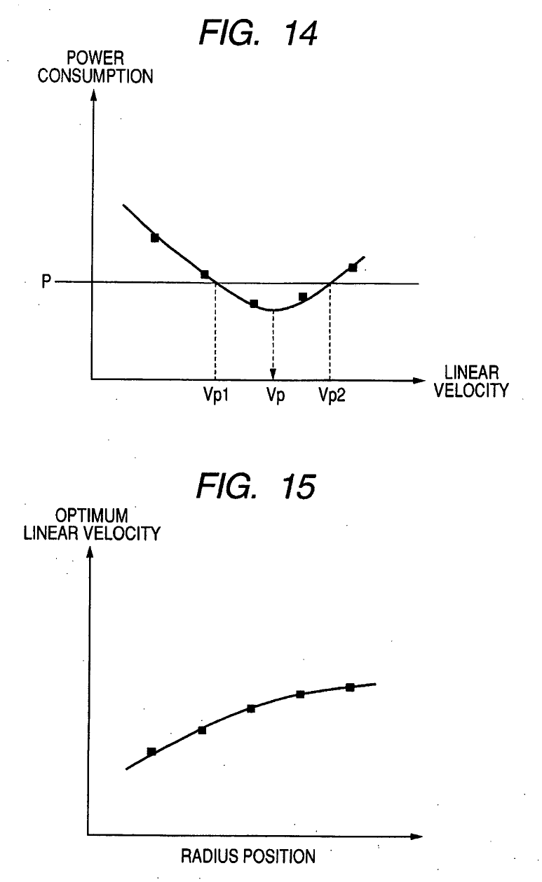

After the measurement in the plurality of radius positions is completed, the learning is finished in Step S1309 and a table in which the optimum linear velocity data are associated with the radius positions is stored in the memory (memory 103 or EEPROM 112). FIG. 15 shows a calculated relationship between the radius position of the optical disk and the optimum linear velocity for power saving.

Next, a linear velocity setting method for an actual recording operation will be described. When an address in which data is recorded is determined, the CPU 110 calculates a radius position corresponding to the address. Then, an optimum linear velocity value in this radius position is calculated based on radius-position to linear velocity data stored in the memory.

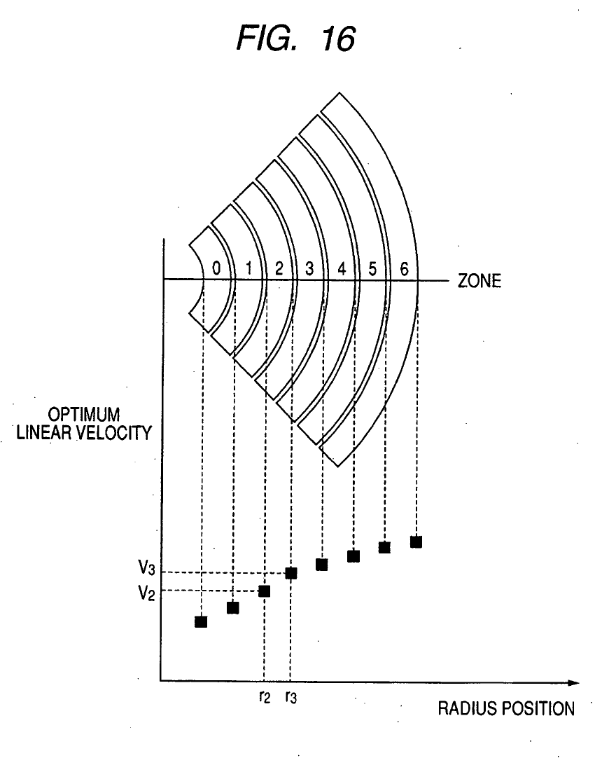

Here, a summary of calculation of the linear velocity value will be described with reference to FIG. 16. The optical disk is divided into a plurality of zones in a radius direction thereof based on the radius-position to linear velocity data. A case where the optical disk is divided into seven zones according to radius positions will be described.

Radii for specifying boundaries between the respective zones are expressed by r₀ to r₆. Optimum linear velocities in the respective zone boundaries are expressed by V₀ to V₆. When a radius position for recording is expressed by r, a zone including the radius position r is detected. As shown in FIG. 16, when the radius position is included in a “zone 2”, radii r₂ and r₃ for specifying the boundaries of the “zone 2” and optimum linear velocities V₂ and V₃ at respective radius positions are read out from the memory.

Next, the following interpolation calculation is performed based on the read out data to obtain a linear velocity value V associated with the radius position r.
V=α(r−r₂)+V₂
Here, α is expressed by the following expression.
α=(V₃−V₂)/(r₃−r₂)

Therefore, it is possible to obtain the optimum linear velocity V for power saving which is associated with the radius position r for recording.

In this embodiment, the linear velocity is calculated by linear interpolation. The interpolation can be also performed by polynomial approximation based on respective boundary points. Interpolation based on a spline curve or the like can be used.

A condition including a temperature is stored while learning data is obtained. When the condition significantly changes, the learning data is measured again.

As described above, in this embodiment, the learning for obtaining the optimum linear velocities for power saving which are associated with the plurality of radius positions is performed in advance. Therefore, the optimum linear velocity can be instantly obtained at the time of recording. In the third embodiment, the method of setting the optimum linear velocity for recording is described. In the case where information is reproduced from the optical disk, while the linear velocity is changed in each of the plurality of radius positions of the optical disk, the power consumption is measured to prepare the table indicating the relationship between the linear velocity and the power consumption in each of the radius positions. At the time of reproducing, the optimum linear velocity is set according to the reproducing position with reference to the table.

This application claims priority from Japanese Patent Application No. 2005-137313 filed on May 10, 2005, which is hereby incorporated by reference herein.

What is claimed is:

1. An optical information recording and reproducing apparatus, comprising:
a circuit for performing one of recording information on an information recording medium and reproducing the information recorded thereon;
a storing circuit for storing linear velocities for the information recording medium based on power consumption at recording and reproduction; and
a setting circuit for separately setting linear velocities at recording and reproduction based on the linear velocities for recording and reproduction which are stored in the storing circuit.

2. The optical information recording and reproducing apparatus according to claim 1, wherein the setting circuit sets a linear velocity in accordance with a radius position of the information recording medium at each of recording and reproduction based on a table for holding a relationship between a radius position of the information recording medium and a linear velocity associated with power consumption.

3. An optical information recording and reproducing apparatus, comprising:
a measurement circuit for measuring power consumption at one of recording and reproduction;
a search circuit for obtaining a linear velocity at which power consumption becomes minimum based on the power consumption measured by the measurement circuit; and
a setting circuit for setting the linear velocity for the one of recording and reproduction, which is obtained by the search circuit.

4. The optical information recording and reproducing apparatus according to claim 3, wherein, when the linear velocity at which power consumption becomes minimum is detected, the setting circuit holds the detected linear velocity as a linear velocity of the recording medium.
